(19) United States
(12) Patent Application Publication
(10) Pub. No.: US 2025/0179650 A1
(43) Pub. Date: Jun. 5, 2025

(54) Systems, Devices and Methods for Screening and Electrolysis for Utilization of Chemical Feedstocks

(71) Applicants: M2X Energy Inc., Rockledge, FL (US); University of Central Florida Research Foundation, Inc., Orlando, FL (US)

(72) Inventors: Hsiang-Sheng Chen, Orlando, FL (US); Paul Yelvington, Rockledge, FL (US); Edwin Yik, Orlando, FL (US)

(73) Assignees: M2X Energy Inc., Rockledge, FL (US); University of Central Florida Research Foundation, Inc., Orlando, FL (US)

(21) Appl. No.: 18/939,163

(22) Filed: Nov. 6, 2024

Related U.S. Application Data
(60) Provisional application No. 63/547,487, filed on Nov. 6, 2023.

(51) Int. Cl. C25B 1/02; C25B 9/23; C25B 11/032; C25B 11/065; C25B 11/097; C25B 13/05; C25B 15/08; H01M 4/88; H01M 4/92; H01M 8/0234

(52) U.S. Cl. CPC C25B 1/02; C25B 9/23; C25B 11/032; C25B 11/065; C25B 11/097; C25B 13/05; C25B 15/085; H01M 4/8807; H01M 4/926; H01M 8/0234

(57) ABSTRACT

A screening gas diffusion material, which can have a porosity and which can be a layer and which can be a membrane, for use in electrolysis systems and methods, such as in an electrolyzer, permits smaller molecules, such as methanol, to pass through while excluding larger organic contaminants from reaching the catalyst surface. The screening layer minimizes the energy penalty caused by the larger organic impurities while maintaining the cell potential below the threshold where catalysts are potentially oxidized.

This application claims under 35 U.S.C. § 119(e)(1) the benefit of the filing date of, and claims the benefit of priority to, U.S. provisional application Ser. No. 63/547,487 filed Nov. 6, 2023, the entire disclosure of which is incorporated herein by reference.

### BACKGROUND OF THE INVENTION

### Field of the Invention

The present inventions relate to methods, devices and systems that provide for the use of screening gas diffusion layers in electrolysis methods for processing chemical feedstocks to provide a material for use as an end product, an intermediate product for use in further reactions, processes, apparatus and methods and combinations and variations of these. In particular, embodiments of the present inventions relate to new and improved methods, devices and systems for utilizing gas diffusion electrode technologies, catalyst & catalyst support designs, and electrolysis technologies to quickly and efficiently directly process a crude feedstock to provide a material for use in other processes or apparatus.

Hydrogen gas is an important tool for decarbonization of several sectors, including manufacturing and electric utilities, however the cost of storage and transportation of hydrogen gas presents an obstacle to widespread adoption.

Hydrogen-containing organic compounds that exist as liquids at ambient temperature and pressure, such as methanol, methylcyclohexane, formic acid, or dimethyl ether, are high-density, low-cost hydrogen carriers more conducive for transportation and storage than hydrogen gas. Although these hydrogen carriers can significantly reduce the cost and complexity of storage and transportation, they require conversion to hydrogen gas at the point to use. The need for point-of-use conversion of sourcing hydrogen from these media can be achieved through existing thermal and electrochemical technologies, and the energy required from such conversion should be accounted for when determining the economic feasibility of the overall conversion pathway, providing further disincentives to their use.

One important metric for evaluating hydrogen as an energy carrier is its carbon intensity. To ensure that using chemicals as hydrogen carriers is truly sustainable, these chemicals themselves must also be produced with a low carbon footprint. In recent years, there has been a shift toward producing low-carbon chemicals using decentralized, small-scale infrastructure. However, small-scale facilities often forgo the benefits of economies of scale, resulting in higher production and purification costs compared to conventional, large-scale chemical plants. This trade-off highlights the need for innovation in utilization of crude feedstock or efficient purification technologies and cost management strategies to make decentralized low-carbon chemical production economically viable.

Prior to the present inventions conventional thermochemical steam reforming and autothermal reforming, as well as electrolysis has been unsuccessful at providing a viable system to convert these liquid organic compounds in crude form to hydrogen gas and CO₂ in an efficient, economical and commercially viable manner. One of many problems with electrolysis methods is that, prior to the present inventions, electrolysis technologies required the use of pure organic feedstocks in order to avoid the energy penalty caused by the presence of organic impurities. Similarly, this prior electrolysis technologies required distillation of crude organic feedstock to remove these impurities, which increases the cost and carbon intensity. Methanol upgrading through distillation, for example, can add approximately 10% or more to levelized cost and carbon intensity.

While prior studies have focused on improving the efficiency of the electrolysis technologies as individual components, technical challenges remain significant as the catalysts commonly used for these electrolysis technologies are subject to performance degradation due to impurities in the feedstock. Thus, it is believed that these attempts have failed to solve the problems of using electrolysis technologies as a point-of-use conversion technology. Taking methanol electrolysis technologies, for example, the platinum (Pt) group metals (PGM) at its anode are extremely sensitive to organic impurities. These impurities, even at concentrations as low as hundreds to thousands of ppm (parts per million), can compromise the energy efficiency of electrolysis, making it commercially unviable and thus providing a significant impediment to use and adoption. Thus, prior to the present inventions, the purification of chemical feedstocks via energy intensive distillation or similar means, which is especially costly and energy-intensive for decentralized production of organic feedstock, was believed to be necessary.

The term “flare gas” and similar such terms should be given their broadest possible meaning, and would include gas generated, created, associated or produced by, or from, oil and gas production, hydrocarbon wells (including shale, conventional and unconventional wells), petrochemical processing, refining, landfills, waste water treatment, livestock production, and other municipal, chemical and industrial processes. Thus, for example, flare gas would include stranded gas, associated gas, landfill gas, vented gas, biogas, digester gas, small-pocket gas, and remote gas.

Typically, the composition of flare gas is a mixture of different gases. The composition can depend upon the source of the flare gas. For instance, gases released during oil-gas production mainly contain natural gas. Natural gas is more than 90% methane (CH₄) with ethane and smaller amounts of other hydrocarbons, water, N₂ and CO₂ may also be present. Flare gas from refineries and other chemical or manufacturing operations typically can be a mixture of hydrocarbons and in some cases H₂. Landfill gas, biogas or digester gas typically can be a mixture of CH₄ and CO₂, as well as small amounts of other inert gases. In general, flare gas can contain one or more of the following gases: methane, ethane, propane, n-butane, isobutane, n-pentane, isopentane, n-hexane, ethylene, propylene, 1-butene, carbon monoxide, carbon dioxide, hydrogen sulfide, hydrogen, oxygen, nitrogen, and water.

The majority of flare gas is produced from smaller, individual point sources, such as a number of oil or gas wells in an oil field, a landfill, waste water treatment plant or a chemical plant. Prior to the present inventions flare gas, and in particular flare gas generated from hydrocarbon producing wells, and other smaller point sources, was burned to destroy it, and in some instances may have been vented directly into the atmosphere. This flare gas could not be economically recovered and used. The burning or venting of fare gas, both from hydrocarbon production and other endeavors, raises serious concerns about pollution and the production greenhouse gases.

As used herein unless specified otherwise, the terms “syngas” and “synthesis gas” and similar such terms should be given their broadest possible meaning and would include gases having as their primary components a mixture of H₂ and CO; and may also contain CO₂, N₂, and water, as well as, small amounts of other materials.

As used herein unless specified otherwise, the term “product gas” and similar such terms should be given their broadest possible meaning and would include gases having H₂, CO and other hydrocarbons, and typically significant amounts of other hydrocarbons, such as methane.

As used herein unless specified otherwise, the term “reprocessed gas” includes “syngas”, “synthesis gas” and “product gas”.

As used herein, unless specified otherwise, the term “crude methanol” is defined as methanol produced in a methanol synthesis loop prior to the removal of water, dissolved gases, or other contaminants. Crude methanol often contains 5-20 wt % water, dissolved gases (e.g., 1-2 wt % CO₂) and trace contaminants (e.g., ethanol). As used herein, unless specified otherwise, the term “stabilized methanol” is defined as crude methanol that has passed through a flash operation (e.g., a single-stage flash drum) to reduce the concentration of dissolved gases and other light components. Often stabilized methanol will have <1% CO₂ and most typically about 0.5 wt % CO₂. As used herein, the term “grade methanol” includes methanol that meets a purity standard such as the ASTM AA standard (D1152) or IMPCA methanol reference specifications. Thus, as used herein, unless stated otherwise the term “grade AA methanol” means that the methanol contains at least 99.85% methanol by weight (dry base). As used herein, unless stated otherwise the term “grade methanol” means that the methanol contains at least 99.5% methanol by weight (dry base).

As used herein, unless specified otherwise, the term “feedstock” refers to the material that is supplied or feed into an electrolysis assembly for an electrolysis method to be performed on that material.

As used the term, unless specified otherwise, the terms “crude” and “crude feedstock” and similar such terms, means a feedstock that has about 50 ppm or more, 100 ppm or more, 0.1% or more, 1% or more 2% or more impurities, 5% or more impurities, 10% or more impurities, from about 50 ppm to 10% impurities, from about 5% to 20% impurities, and would include materials having this level of impurities that has not been processed, cleaned or refined, from its point of origin or from its initial making. Impurities include materials such as dissolved CO₂, and organics having a molecular weight greater than the molecular weight of the feedstock material, and any material that would poison the catalyst. Water would not be considered an impurity when determining the % impurities in a crude feedstock for applications such as electrolysis and steam reforming, since water is a co-reactant in those applications.

As used herein, unless specified otherwise, the terms “cost,” “costs,” “price,” “prices,” “capital cost”, in general mean the amount of money that a customer is required to pay for the transfer of title or possession of a material or goods from the holder of the material or goods to the customer. Thus, cost is the expenditure required to create and sell products and services, or to acquire assets. Capital cost as used herein, is the cost of the property, equipment and facilities that makes up a plant or facility, such as a chemical processing plant. These terms should be given their definitions as used in the US Generally Accepted Principals of Accounting (GAAP) and as used in the International Financial Reporting Standards (IFRS), the entire disclosures of each of which are incorporated herein by reference.

As used herein, unless stated otherwise, the terms and symbols “dollars,” “dollar” and “$” refer to United States (US) dollars.

As used herein unless specified otherwise, the term “CO₂e” is used to define carbon dioxide equivalence of other, more potent greenhouse gases, to carbon dioxide (e.g., methane and nitrous oxide) on a global warming potential basis of 100 years, based on Intergovernmental Panel on Climate Change (IPCC) Fifth Assessment Report (AR5) methodology. The term “carbon intensity” is taken to mean the lifecycle CO₂e generated per unit mass of a product.

In general capital intensity (CI), is the ratio of the cost of a particular piece of equipment, or the cost of all of the pieces of equipment needed to conduct a particular manufacturing process, e.g., a chemical process, vs. the production or output capacity of that piece of equipment or pieces of equipment. In particular, Cl as used herein, unless expressly stated otherwise, is the cost in US dollars for a particle piece of equipment or particular pieces of equipment (i.e., a production unit), vs the capacity or output of a product (e.g., rated capacity, projected capacity or actual operating capacity) in bpd from that particular piece of equipment or production unit. As such, the units for CI are US dollars/bpd.

As used herein, unless specified otherwise, the terms % and weight % are used interchangeably and refer to the moles of a first component as a percentage of the moles of the total, e.g., formulation, mixture, material or product.

As used herein unless specified otherwise, the terms “substantially” or “essentially” mean nearly totally or completely, i.e., 98% or greater of the given quantity.

As used herein unless specified otherwise, the term “substantially free” refers to the nearly complete or complete absence of a given quantity i.e., 2% or less of the given quantity.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

Generally, the term “about” as used herein unless stated otherwise is meant to encompass the greater of a variance or range of ±10% or the experimental or instrument error associated with obtaining the stated value.

As used herein, unless stated otherwise, room temperature is 25° C., and standard temperature and pressure is 15° C. and 1 atmosphere (1.01325 bar). Unless expressly stated otherwise all tests, test results, physical properties, and values that are temperature dependent, pressure dependent, or both, are provided at standard temperature and pressure.

This Background of the Invention section is intended to introduce various aspects of the art, which may be associated with embodiments of the present inventions. Thus, the forgoing discussion in this section provides a framework for better understanding the present inventions, and is not to be viewed as an admission of prior art.

### SUMMARY

There is a longstanding and unmet need for the ability to use crude feedstocks in electrolysis apparatus and methods.

There is a longstanding and unmet need for the storage, generation and transportation of hydrogen. A significant component of this longstanding problem is the lack of low carbon intensity feedstock and economical conversion of a crude liquid organic hydrogen carrier (“LOHC”) compounds into hydrogen gas. A further significant component of this long standing problem is the inability to have point of use conversion of crude LOHC compounds to hydrogen gas.

There is a longstanding problem of being unable to directly use a crude LOHC as a feedstock (i.e., a crude feedstock), in electrolysis systems to provide hydrogen gas. In particular, there has been a longstanding problem of having to using expensive and energy intensive purification processes, such as distillation, to purify the crude feedstock before it can be used in electrolysis technologies to convert the feedstock into hydrogen. Moreover, this problem includes the inability to directly use crude methanal as a feedstock in an electrolysis system and method for conversation into hydrogen.

There is a longstanding and unmet need to be able to bypass distillation, reduce cost and carbon intensity, there remains a need for more efficient design elements in electrolyzers and methods of using crude feedstock in electrolyzers without sacrificing cell performance.

The present inventions, among other things, solve these problems and needs by providing the articles of manufacture, devices and processes taught, and disclosed herein.

The comprehensive cost and carbon intensity, considering the integrated supply chain from initial production of the hydrogen carrier to its use in an electrolysis technology, as well as subsequent use of the hydrogen in for example an engine, can be significantly lowered if purification steps, otherwise employed to upgrade crude feedstock to grade feedstock, can be avoided by converting crude feedstock directly into hydrogen gas through the use of embodiments of the present inventions.

In general, in embodiments of the present inventions there is provided the design of a screening gas diffusion layer (“GDL”) at the interface where the feedstock contacts the catalysts, between the catalyst layers and the feedstock flow field plates (usually made of graphite or aluminum), that permits smaller molecules, such as methanol, to pass through while excluding larger organic contaminants from reaching the catalyst surface, and hence avoid the detrimental effect caused by larger organic contaminants. This carries an added benefit of maintaining the cell potential below thresholds where metal-based catalysts, if they are employed, could become oxidized and for which such oxidation of those catalysts leads to lower conversion activity, while still preserving the operation of the electrolyzer at industrially relevant current densities (>50 mA cm⁻²geo)

In general, in embodiments of the present inventions there are provided a selective gas diffusion layer which is capable of selectively allowing desired reactants to reach the catalyst layer. In particular, the selective gas diffusion layer of the disclosure is a porous material wherein the pores allow for small molecules such as methanol and water to permeate through the layer while preventing impurities, including larger hydrocarbon materials, larger alcohols, esters, ketones, and other impurities from permeating.

In general, in embodiments of the present inventions there are provided a method for electrolysis of crude methanol feedstocks using an electrolyzer assembly comprising one or more gas diffusion layers, a proton exchange membrane, and flow field plates, wherein a screening gas diffusion layer is positioned between the proton exchange membrane and the one or more flow field plates.

In general, in embodiments of the present inventions there are provided a method of this disclosure allows the direct use of a crude hydrogen carrier feedstock, including, but not limited to methanol and other liquid organic hydrogen carriers, within electrolyzers for hydrogen gas generation, removing the requirement and associated costs of upgrading and distillation and consequently reducing the carbon intensity of the overall process. This allows the operation of distributed, modular systems to become more economically viable, when such upgrading process steps can be eliminated.

In general, in embodiments, a screening gas diffusion material, which can have a porosity and which can be a layer and which can be a membrane, for use in electrolysis systems and methods, such as in an electrolyzer, permits smaller molecules, such as methanol, to pass through while excluding larger organic contaminants from reaching the catalyst surface. The screening material minimizes the energy penalty caused by the larger organic impurities while maintaining the cell potential below the threshold where catalysts are potentially oxidized.

Thus there is provided an assembly for use in a system to conduct an electrochemical reaction, the assembly having: a first member, having flow channels therein; current collector, in electrical contact with the first member; a screening gas diffusion material, in fluid contact with the flow channels, whereby a crude feedstock in the flow channels would be in fluid communication with a first side of the screening gas diffusion material; a catalyst adjacent a second side of the screening gas diffusion material; and, wherein the assembly is configured for placement in the system so that the catalysis is positioned facing a second membrane and away from the crude feedstock in the flow channels.

Further there is provided these assemblies, systems and methods having one or more of the following features: wherein the first member is graphite; wherein the screening gas diffusion material has a porosity defined by a pore size of less than about 0.5 μm; wherein the catalyst is at least one of Ni, Co, NiOx, Mn complexes, Fe complexes, MoSx, CdS, CdSe, and GaAs; wherein the first member is aluminum; wherein the screening gas diffusion material defines a layer having a porosity defined by a pore size of less than about 0.5 μm; and, wherein the catalyst is at least one of Pt, Au, Pd, Ru, Ir, Mn and Fe.

Further there is provided these assemblies, systems and methods having one or more of the following features: wherein the screening gas diffusion material is at least one of a nonwoven carbon fiber paper, a woven carbon cloth, a carbon foam, a carbon nanotube, graphene, a carbon nanotube felt, a polyolefin, a polyethylene, a polypropylene, a polyester, a polyphenylene sulfide and a zeolite; wherein the screening gas diffusion material is at least one of a nonwoven carbon fiber paper, a woven carbon cloth, a carbon foam, a carbon nanotube, and graphene; wherein: the screening gas diffusion material is at least one of a carbon nanotube felt, a polyolefin, a polyethylene, a polypropylene, a polyester, a polyphenylene sulfide and a zeolite; wherein the screening gas diffusion material is a layer; wherein the screening gas diffusion material is a membrane; wherein the pore size is less than 0.1 μm; and, wherein the catalyst consists essentially of a PtRu based catalyst.

Still further there is provided these assemblies, systems and methods having one or more of the following features: wherein the assembly is configured to operate as an anode in the system; and wherein the assembly is configured to process a crude methanol feedstock in the flow channels; and, wherein the crude methanol feedstock has 2% or more impurities, and the impurities comprise organic molecules having a molecular weight greater than that of methanol.

Still further, there is provided these assemblies, systems and methods wherein the system is a fuel cell or is operated as a fuel cell.

Still further, there is provided these assemblies, systems and methods wherein the system is an electrolier or is operated as an electrolyzer.

Additionally, there is provided a system for performing electrolysis of a crude feedstock, wherein the crude feedstock is a primary component, the cell having: a first end having an inlet port and a return port; a second end having an outlet port; a first flow field component, having a flow channel in fluid communication with the inlet port and the return port of the first end plate; a second flow field component, having a flow channel in fluid communication with the outlet port of the second end plate; a first electrical connector affixed to the first flow field component; a second electrical connector affixed to the second flow field component; and, a screening gas diffusion assembly between the first and second flow field components, whereby a first side of the screening gas diffusion assembly is in fluid communication with the flow channel of the first flow field component; and whereby a second side of the screening gas diffusion assembly is in fluid communication the flow channel of the second flow field component. Further there is provide the forgoing system wherein the screening gas diffusion assembly has: a first gas diffusion material; an exchange membrane; a first catalyst; wherein the first gas diffusion material is in fluid communication with the inlet and return port of the first end component; wherein the first gas diffusion material is in fluid communication with the exchange membrane; and, wherein the gas diffusion material is configured and positioned to screen an impurity in the crude feedstock from the catalysis.

In addition, there is provided these assemblies, systems and methods having one or more of the following features: whereby the gas diffusion material is configured to protect the catalyst from poising by the impurity; whereby the gas diffusion material is configured to reduce an energy penalty caused by the impurities in the feedstock; whereby the gas diffusion material is configured to reduce an energy penalty caused by the impurities in the feedstock; whereby the reduction in the energy penalty is about 5 by kWh/kg H₂ or more, for a current density of at least about 0.2 A cm⁻²; whereby the reduction in the energy penalty is about 5 by kWh/kg H₂ or more, for a current density of at least about 0.2 A cm⁻²; and, wherein the gas diffusion material is a layer; wherein the gas diffusion material is a membrane.

Yet further, there is provided these assemblies, systems and methods having one or more of the following features: wherein the screening gas diffusion assembly has: a second gas diffusion material; a second catalyst; wherein the second gas diffusion material is in fluid communication with the outlet port of the second end component; and, wherein the second gas diffusion material is in fluid communication with the exchange membrane.

Moreover, there is provided these assemblies, systems and methods having one or more of the following features: wherein, the first and second catalyst are different; wherein the second gas diffusion material is a layer; wherein the second gas diffusion material is a membrane; wherein the first, the second or both gas diffusion materials has a porosity defined by a pore size of less than about 0.5 μm; wherein the first catalyst is at least one of Ni, Co, NiOx, Mn complexes, Fe complexes, MoSx, CdS, CdSe, and GaAs; wherein: the first, the second or both gas diffusion materials has a porosity defined by a pore size of less than about 0.5 μm; the first catalysts is at least one at least one of Pt, Au, Pd, Ru, Ir, Mn and Fe; wherein the first, the second or both gas diffusion materials comprise at least one of a nonwoven carbon fiber paper, a woven carbon cloth, a carbon foam, a carbon nanotube, graphene, a carbon nanotube felt, a polyolefin, a polyethylene, a polypropylene, a polyester, a polyphenylene sulfide and a zeolite; wherein: the first, the second or both gas diffusion materials comprise at least one of a nonwoven carbon fiber paper, a woven carbon cloth, a carbon foam, a carbon nanotube, and graphene; wherein: first, the second or both gas diffusion materials comprise at least one of a carbon nanotube felt, a polyolefin, a polyethylene, a polypropylene, a polyester, a polyphenylene sulfide and a zeolite; wherein the first, the second or both gas diffusion materials has a pore size of about 0.5 μm to 0.05 μm; wherein the first catalyst consists essentially of a PtRu based catalyst; wherein the first, the second or both flow field components are plates having graphite; wherein the first, the second or both flow field components are plates having aluminum; wherein the crude feedstock primary component is methanol; wherein the crude feedstock primary comment consists of methanol; wherein the crude feedstock primary component is methanol, and wherein the crude feedstock is 0.1% or more impurities; wherein the crude feedstock primary component is methanol, and wherein the crude feedstock is 2% or more impurities; wherein the crude feedstock primary component is methanol, and wherein the crude feedstock is about 5% or more impurities; wherein the crude feedstock primary component is methanol, and wherein the crude feedstock is about 0.1% to about 10% impurities; and, wherein the crude feedstock primary component is methanol, and wherein the crude feedstock is about 1% to about 5% impurities.

Furthermore, there is provided a method of producing hydrogen gas from a crude methanol feedstock in an electrolysis assembly, the method including: flowing the crude methanol feedstock into an inlet of an electrolysis assembly; in the electrolysis assembly, placing the crude methanol feedstock in contact with a screening gas diffusion assembly; the screening gas diffusion assembly screening an impurity in the crude feedstock form the catalyst; apply electricity to the electrolysis assembly to generate hydrogen from the crude methanol feedstock; and, wherein, an energy penalty is reduced.

Moreover, there is provided these assemblies, systems and methods having one or more of the following features: wherein the energy penalty is reduced by about 5 kWh/kg H₂ or more, for a current density of at least about 0.2 A cm⁻²; wherein the energy penalty is reduced by about 2 to 15 kWh/kg H₂, for a current density of about 0.2 A cm⁻² to 0.7 A cm⁻²; wherein the screening gas diffusion assembly is a material having an average pore size of less than about 0.5 μm; wherein the screening gas diffusion assembly is a material having an average pore size of less than about 0.1 μm; wherein the screening gas diffusion assembly is a material having an average pore size of less than about 0.05 μm; wherein the screening gas diffusion assembly is a material having an average pore size of 0.5 μm to about 0.05 μm.

In addition, there is provided a transportation device having: a fuel tank, the fuel tank containing a crude methanol; any of these systems, and a power module.

Further, there is provided these transportation devices wherein the device is selected from the group consisting of a car, a truck, a buss, a ship, and a train locomotive.

### BRIEF DESCRIPTION OF THE DRAWINGS

FIG. 1 is an exploded perspective view of an embodiment of a membrane electrode assembly in accordance with the present inventions.

FIG. 2 is a perspective view of an embodiment of a membrane electrode assembly and process of directly using crude feedstock to provide hydrogen gas and carbon dioxide in accordance with the present inventions.

FIG. 3 is a graph showing the relationship between electricity required per kg hydrogen gas produced and operating current densities for methanol electrolysis using commercially available PtRu catalysts.

FIG. 4 is an exploded perspective view of an embodiment of components of a membrane electrode assembly in accordance with the present inventions.

FIG. 4A is an enlarged cross sectional view of a portion of the assembly in FIG. 4 showing an embodiment of the interface between the liquid, the gas diffusion material, and the catalyst and an illustration of how the methanol selective material blocks larger organic impurities from reaching the catalyst in accordance with the present inventions.

FIG. 5 is cross-sectional schematic of an embodiment of components of a membrane electrode assembly showing an embodiment of the alignment of components, in accordance with the present inventions.

FIG. 6 is a schematic flow diagram of a transportation system based on a crude methanol fuel source.

### DESCRIPTION OF THE PREFERRED EMBODIMENTS

In general, embodiments of the present inventions relate to electrolysis methods and systems that have a gas diffusion material. The gas diffusion material enables the electrolysis methods and systems to use crude feedstocks, without suffering the typical detrimental effects of using crude feedstocks, such as increased power consumption, shortened lifetime of the components in the system, and combinations and variations of these problems. The present electrolysis methods and system having gas diffusion materials can efficiently and economically process curd feedstocks to provide an electrolysis product.

It is believed that prior to the present inventions there was no electrolysis system and no gas diffusion electrode (GDE) that targeted crude feedstock, and provided a system and method that had general and commercial utility for processing crude feedstocks. In general, the present inventions address these longs standing needs. In general, depending on the material that is used as the crude feedstock and the impurity composition of that crude feedstock, embodiments of the present inventions use of a screening gas diffusion material, which can be a layer, which can be a membrane, can reduce the electricity consumption of the system and method by at least 2, at least about 5, at least about 10, at least about 15, at least about 20, from about 2 to 15, from about 5 to 20, and from about 10 to 25 kWh per kg of gas produced, relative to operation without a screening gas diffusion material, at the same current density.

It is believed that prior to the present inventions there was no electrolysis system and no gas diffusion electrode that targeted a crude methanol feedstock, and provided a system and method that had general and commercial utility for processing crude methanol feedstocks. In general, embodiments of the present inventions address these longs standing needs. In general, depending on the impurity composition of the crude methanol feedstock, the present inventions use of a screening gas diffusion material, which can be a layer, which can be a membrane, can reduce the electricity consumption of the system and method by, for example, at least 2, at least about 5, at least about 10, at least about 15, at least about 20, from about 2 to 15, from about 5 to 20, and from about 10 to 25 kWh per kg of H₂ produced, relative to operation without a screening gas diffusion material, which can be a layer, which can be a membrane, at the same current density.

Typically, a reduction of electrical consumption of at least about 2 to 20 kWh per kg of H₂ produced is obtainable when the current density is in the range of 50 mAcm⁻² geo and greater, and up to at least 2500 mAcm⁻² geo. (Unless specifically stated otherwise surfaces area measurements as used for current densities are geometric surface area, i.e., geo.)

Moreover, although this specification focusses on methanol, it is to be understood that the gas selective gas diffusion systems and methods of the present inventions can serve as a more general option for chemical purification in catalyst-driven processes where larger organic species are present and can poison the catalyst, result in high, uneconomical energy usages and both.

In general, embodiments of the present systems and methods can be applied in small-scale hydrogen gas generation at locations, especially where electricity cost is high, among other uses. Similarly, these systems and methods can be used for crude organic feedstock electrolysis intended to produce hydrogen gas at the point of use. These methods and systems lower the cost of chemical purification, particularly for small-scale, decentralized production of chemicals, which generally carries higher upgrading costs relative to conventional, large-scale facilities, among other things.

In general, embodiments of the electrolysis systems and methods of the present inventions having the gas diffusion material of the present inventions, which can be in the form of a layer, which can be in the form of a membrane, can include any type of system and methods that employs electrolysis or electrochemical reactions. Thus, in general these systems would include, for example, an electrochemical cell, a membrane electrode assembly (“MEA”), which include gas diffusion electrodes (“GDEs”) and a proton exchange membrane (“PEM”), an electrochemical reactor, a microfluidics system and methods and combinations and variations of these.

In embodiments of the present inventions include the utilization of gas diffusion materials of the present invention for fuel cell technologies. Fuel cells and fuel cell methods typically use an electrochemical reaction of a fuel source to generate electricity and byproduct materials. Typically, fuel cells use hydrogen as the fuel source in an electro chemical reaction to generate electricity and water. In embodiments, the fuel cells have the gas diffusion materials of the present invention. In embodiments a fuel cell is part of a system having an embodiment the present electrolysis system and a storage tank having a crude fuel source for the fuel cell.

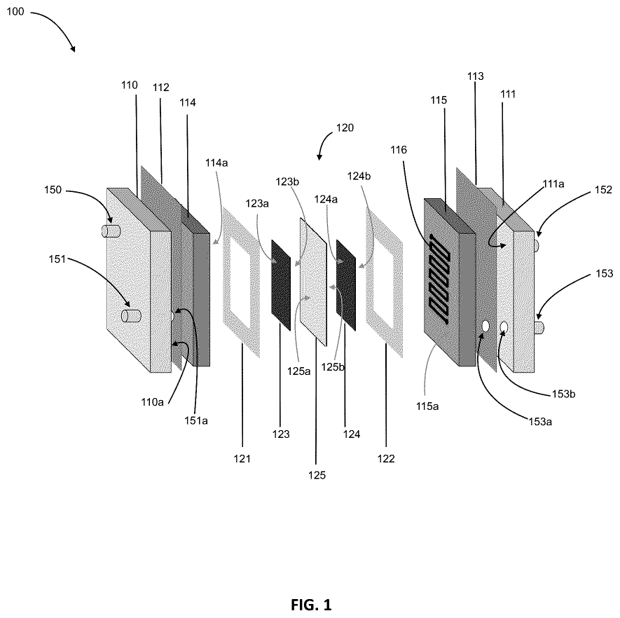

Embodiments of the present fuel cells can have the same general components and configuration of the electrolysis assemblies, e.g., electrolyzers. Generally, the application of the electricity and operation of the systems are different. Thus, in an embodiment of fuel cells, the fuel has the same general components and cell of FIG. 1 has the same general configuration for fuel cell use and for an electrolyzer. Such as, a methanol fuel cell vs a methanol electrolyzer. Thus, in the methanol fuel cell the methanol is oxidized on the anode and reduced oxygen to water at the cathode. In methanol electrolyzer the methanol is oxidized on the anode and reduce the protons to hydrogen gas.

In general, the gas diffusion material (“GDM”), which can be in the form of a layer (“GDL”) assists gas molecules to be transported from a solution to the catalyst layer in the electrolysis system. The gas diffusion layers of the present inventions are preferably configured as a membrane. One side is contacting the flow field and the other side directly contacts the catalyst layer. In embodiments of the present inventions include using gas diffusion layers as filter to permit the flow of smaller molecules, such as methanol, while blocking the low of larger molecules, such as organic contaminates in crude methanol. The gas diffusion material can be made from materials such as carbon cloth, or other electron conductive porous materials, in which can be a combination of porous carbon, zeolites and other materials.

In general, the GDM has the catalyst layer directly adjacent to, and preferably integral with the GDM. In this manner, the GDM is configured as a layer, including as a membrane having the catalysis as a layer on one side of the layer or membrane, which would be the side away from the crude feedstocks, e.g., crude methanol.

In general, the catalyst can be any metal or metal oxide particles that is physically supported by support materials, such as and not limited to cerium oxides, ruthenium oxides, and different forms of carbon: carbon black, activated carbon, graphite, graphene.

Thus, and in general, the present screening gas diffusion material, e.g., a layer, a membrane, for use in an electrolysis system permits smaller molecules, such as methanol, to pass through while excluding larger organic contaminants from reaching a catalyst surface. In this manner the GDM minimizes impurities from contacting the catalyst layer, mitigates the poisoning caused by impurities and essentially eliminates the energy penalty caused by large organic impurities while maintaining cell potentials below thresholds where catalysts could become inactive or less active, and maintain preferred current densities, typically >50 mA cm⁻²geo, while not requiring increased bias or cell voltage. Thus, the GDM-electrolysis system solves the long-standing problem of incurring unrealistic energy penalties and preserving catalyst longevity, when using crude feedstocks.

In general, the present inventions address, minimize, mitigate, essentially eliminate and eliminate, the crude feedstock inflicted energy penalty. The crude feedstock inflicted energy penalty is defined as the additional amount of electrical energy required to perform the electrolysis process using a crude feedstock material (“crude feedstock energy input”), when compared to the amount of energy required to perform the electrolysis process on a grade feedstock of the same material (“baseline energy input”). Penalty is a condition that requires additional energy input to the system, relative to the baseline energy inputs, to exact the same or similar system outcome. As used herein, outcome can be defined but not limited to current density, product formation rate, gas product purity, and the like; and energy input can be in the form of electrical, chemical, mechanical, and the like. These energy values are commonly expressed in units of MJ, kJ, kVAh, Wh, kWh, and the like. In a preferred analysis method, the crude versus grade comparison is made for methanol using the same current density, which translates to the same rate of hydrogen production in scenarios where two reactions have the same Faraidaic efficiency.

Thus, keeping units the same for an analysis, the energy penalty for using a crude version of a feedstock, compared to a grade version of the same feedstock can be expressed as.

crude feedstock energy input−grade feedstock energy input=energy penalty. When systems are operated to obtain the same output.

For methanol to hydrogen methods and systems.

crude methanol energy input−grade methanol energy input=energy penalty. When systems are operated to produce the same amount and at the same rate of production of hydrogen gas.

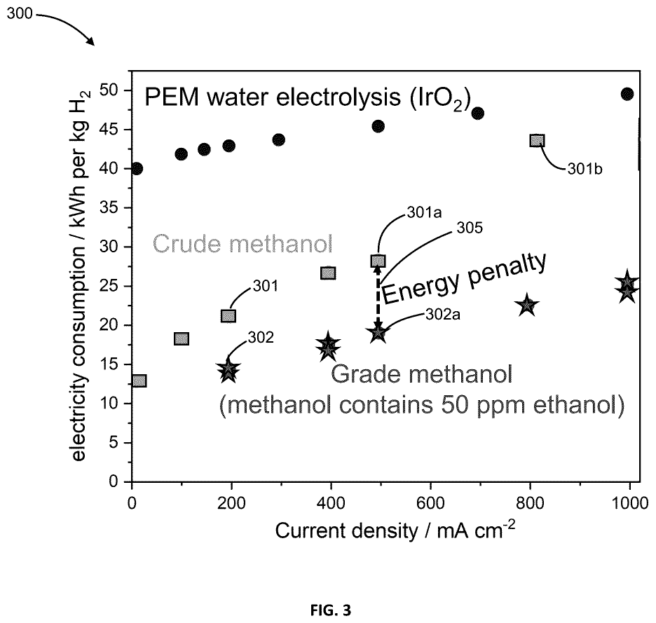

Thus, turning to FIG. 3 there is a graph 300 showing the penalty and limitations of crude methanol electrolysis. The graph 300 shows the relationship between the electricity required to perform the electrolysis (electricity consumption in kWh per kg hydrogen gas produced) and the operating current densities (current density in mA cm⁻² (milliamps per cm²)) for methanol electrolysis and water electrolysis as a reference point. For the water electrolysis a proton exchange membrane electrolyzer was used, having a IrO₂ catalysis at the anode and a Pt catalysis at the cathode. For the methanol electrolysis (both crude and grade) an electrolyzer was used having a PtRu catalysis at the anode and a Pt catalysis at the cathode. The crude methanol was produced from a small scale decentralized reactor that converts natural gas to methanol and contained less than 3% by weight organic impurities. The grade methanol contained 50 ppm of ethanol.

In the graph 300 the electricity used per current density for the crude methanol is shown by the squares, e.g., 301, 301a, 301b. The electricity used per current density for the grade methanol is shown by the stars, e.g., 302, 302a. The energy penalty is the difference between the electricity used for the crude methanol vs the electricity used for the grade methanol at a particular current density. Thus, an example of the energy penalty is shown by double arrow 305. It being understood that this is just one example of the energy penalty, crude methanols having higher impurities will have high energy penalties.

In the operation of the systems to obtain the data for FIG. 3 the feedstocks were dilute with deionized water to methanol concentrations of 5M (molar) before feeding into the electrolysis system.

Current density, as used herein, refers to the amount of electric current flowing per unit cross-sectional area of a material. Electrochemical surface area, as used herein, refers to the electrochemically active surface area of the material.

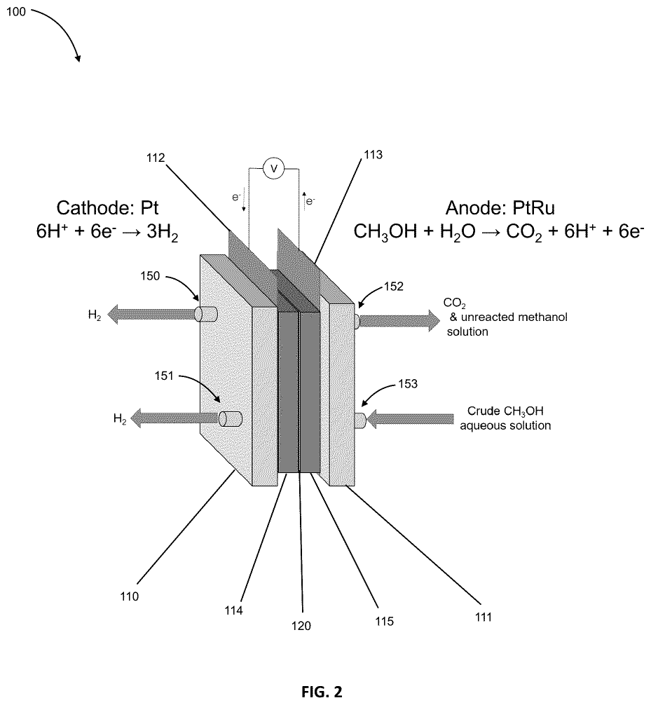

Turning to FIGS. 1 and 2, there is shown an exploded view (FIG. 1) and a perspective view (FIG. 2) of a general embodiment of the present electrolysis assemblies shown as cell 100. The cell 100 has two end components 110, 111, which can be end plates, two current collectors 112, 113, two flow field components 114, 115 which can be plates, e.g., graphite plates, and a screening gas diffusion assembly 120. The flow field component 115 has flow channels 116, flow field component 114 also has flow channels, which are not seen in the view of the figure. The end components 110, 111 have internal surfaces 110a, 111a.

End component 110 has ports 150, 151, which provide openings through which the hydrogen gas produced by the electrolysis leaves the cell 300. End component 111 has port 153 which receives an incoming flow a crude feedstock, here crude methanol. End component 111 has port 152, which provides an opening through which CO₂ and the unreacted feedstock, here crude methanol feed stock, leaves the cell. In embodiments the unreacted feedstock is recirculated for use, the CO₂ may be vented to atmosphere or captured for later use or sequestration. FIG. 1 shows portions of the internal channels 153a, 153b for the flow of crude feedstock, and internal channel 151a for the flow of hydrogen. It being understood that additional input, return and output ports and channels may be present in a cell.

In cell 100, flow field component 115 and collect 113 can serve as the cathode for the cell. Flow field component 114 and collector 112 can serve as the anode for the cell 300. Screening gas diffusion materials 123, 124 would be considered the electrodes for the cell. Screening gas diffusion materials 123, 124 with the catalysis layer would be considered the gas diffusion electrodes for the cell.

When operating the cell as an electrolyzer, the anode will be coated with an oxidation catalyst to oxidize the feed and generate protons that cross the membrane 125 to then be reduced to hydrogen gas at the cathode. This reaction at the cathode is often referred as hydrogen evolution reaction (HER).

When operating the cell as a fuel cell, the anode will be coated with an oxidation catalyst to oxidize the feed and generate protons that cross the membrane. A catalyst capable of reducing oxygen to water is coated on the cathode. This reaction at the cathode is often referred as oxygen reduction reaction (ORR).

The screening gas diffusion assembly 120 has a proton exchange membrane 125, a cathode side gas diffusion material 123, which is a gas diffusion electrode, material 123 has a catalyst (for example a Pt based catalysis). The screening gas diffusion assembly 120 has an anode side gas diffusion material 124, which is a gas diffusion electrode, material 124 has a catalyst to oxidize the feedstock to generate protons (for example a PtRu based catalyst). The screening gas diffusion assembly also has means to seal the assembly within the cell, such as, for example, gaskets 121, 122. Any suitable manner of sealing the cell so that the necessary fluid flows (e.g., gas, liquid or both) and electric circuits are maintained can be used, such as, gaskets, pressure fits, over molding, welding, glues, integral constructions, etc.

The materials 123, 124 can be in the form of a layer, they can be a membrane. The materials 123, 124 have first and second sides, 123a, 123b, 124a, 124b respectively. Flow field components 114, 115 have sides 114a, 115a respectively. The catalysts are preferably on, in, or adjacent to, sides 124a and 123b.

It is understood that while cell 100 and its components are shows as square/rectangular in shape, the cell and these components can be any shape, e.g., circular, elliptical, square, rectangular, curved, and combinations and variations of these.

In general, gaskets or other sealing membrane may be used to seal the electrolytic cell. Similarly, crude feedstocks may be supplied to the cell using any acceptable hoses, compressors, pumps, tanks, linkages, and the like, as may be required.

A system can have one, two, three, four, five or more, ten or more, and hundreds of more cells combined or linked together. For example, a system to use crude methane as a fuel source to power a large container ship could have thousands of cells. Moreover, a cell may have more than one anode and more than one cathode.

When using the cell as an electrolyzer. The catalysis for the cathode side gas diffusion material 123 can be any catalyst that reduce the protons that cross the membrane from the anode. These catalysts are often referred as HER catalysts. For example, it can be a platinum group metal (PGM) based catalyst. Further, the catalyst layer would include metal or metal oxide particles, electron conductive supports such as cerium oxides, ruthenium oxides, and different forms of carbon: carbon black, activated carbon, graphite, graphene. Binders such as sulfonated tetrafluoroethylene based fluoropolymer-copolymers (e.g., Nafion™) or other ionomer are often used to increase the proton transport and physical integrity.

The catalysis can be applied to the gas diffusion membrane as a coating, it can be configured as a separate membrane that is in direct contact with the gas diffusion membrane, it can be on a carried that is held in a bed in direct contact with the gas diffusion membrane, as well as, other configurations. The configuration of the gas diffusion membrane and the catalysis should be such that the gas diffusion membrane shielded the catalysis from the crude feedstock, and in particular, the impurities in the crude feedstock that could poison the catalyst, increase the electricity need to conduct the electrolysis and both. Thus, for example in the embodiment of FIG. 1, the catalyst coating preferably on the side 124a of membrane 124 facing the proton exchange membrane 125.

The catalyst for the anode side gas diffusion membrane 124 can be any catalyst that oxidize organic hydrogen carriers such as methanol, acetic acid. For example, these can be platinum group metal (PGM) based catalysts. Further, the catalyst layer would include metal or metal oxide particles, electron conductive supports such as cerium oxides, ruthenium oxides, and different forms of carbon: carbon black, activated carbon, graphite, graphene. Binders such as Nafion or other ionomer are often used to increase the proton transport and physical integrity.

Pt, Au, Pd, Ru, Ir, Mn, Fe, Ni, Co, NiOx, Mn complexes, Fe complexes, MoSx, CdS, CdSe, and GaAs or combinations thereof can be used as catalysts on the electrodes, either cathode or anode.

In the case of methanol electrolysis, PtRu is a preferred anode catalyst given its low overpotential in methanol oxidation. Typically, a methanol aqueous solution is oxidized on the anode catalyst to form protons and CO₂; the protons are transported from anode to cathode by crossing the proton-exchange membrane to the cathode whereupon they are reduced to form hydrogen gas. As CO₂ cannot cross the membrane, clean separation is achieved, and product CO₂ can then optionally be captured and utilized.

In embodiments the catalyst can be placed on, in or associated with the exchange membrane and the gas diffusion materials, such that the catalysts are on either side of the exchange membrane, e.g., the proton exchange membrane, and then sandwiched between gas diffusion materials.

In embodiments the catalyst can be formulated as an ink using the catalyst powder and the binder like Nafion solution, with solvent such as isopropanol and water and then sprayed or printed onto the gas diffusion material, e.g., a membrane. The catalyst can also be formulated as a paint, or other type of coating and then applied to the gas diffusion material, e.g., a membrane. The catalyst can also be coated or applied to both sides of the exchange membrane, or a separate component on a carrier or membrane sandwiched into the assembly as discussed above.

In general, the gas diffusion materials 123, 124 can be carbon based materials, which is fabricated from carbon fiber, for example, Toray® and SGL® These materials do not have pore size small enough to filter chemical impurities. The anode side gas diffusion membrane and the cathode side gas diffusion membrane can be the same or different materials. Such materials preferably having a porosity defined by pores having an average pore size of 0.5 μm and smaller.

For example, the gas diffusion membrane, which forms a gas diffusion layer, can be made from materials such as zeolite, polymeric membrane, alloy membrane, composite membrane, metal organics framework (MOF), which selectively allows small molecules to traverse through the gas diffusion layer, while excluding larger molecules by tuning the aperture dimensions, solubility/diffusivity, and pore sizes of these selective materials. Moreover, the gas diffusion layer (GDL) may be a nonwoven carbon fiber paper, a woven carbon cloth, a carbon foam, carbon nanotubes, graphene, a carbon nanotube felt, a polyolefin material, a polyethylene material, a polypropylene material, a polyester material, a polyphenylene sulfide material, or a zeolite or other naturally porous material for example. The selective GDL may also be a composite of two or more materials.

In general, the proton exchange membrane 125 can be any polymer that consists of the one or more than one ionomer that promotes proton transportation and physical integrity. Often seen ionomers include tetrafluoroethylene, phenilsulfone, arylene sulfone. The dry thickness of the polymer film is usually a few micrometers to 200 micrometer. For example, the proton exchange membrane can be Nafion 115, Nafion 117, Nafion 119, Nafion 121, Nafion 211, Nafion XL, Celtec®-P, Aquivion E98 series, M Dyneon, XION Nafion, XION Dyneon, Pemion PF1,

It being understood that while the use of a PEM in the screening gas diffusion assembly is preferable, other types of membranes that are typically used in membrane electrode assemblies (MEA) can be employed.

In the cell 100 of FIGS. 1 and 2, the gas diffusion material 123 with catalyst coating on it make up a gas diffusion electrode. Similarly, in cell 100 the gas diffusion layer 124 with catalyst coating on it make up a gas diffusion electrode.

In operation using crude feedstocks, such as crude methanol, the feedstock should be diluted to between 1-10 M (molar). Preferred molar (M) concentrations the feedstock material are from 2 M to 7 M, depending on the operation temperature and the thickness of the GDL at the anode. For crude methanol the preferred molar concentration is at least 2 M, at least 7 M, from 2 to 7 M.

Operating the cell at high temperature such that the liquid feed to the anode is evaporated into gas phase is one potential how the cell can be operated.

In embodiments the impurities can stay in the effluent of the feed to the anode, whether as a single pass or a recycled loop. If the feed has a recycled loop the concentration of the impurities could potentially build up over time, and can be managed by addition of new crude feedstock, or other approaches to maintain the concentration of methanol for effective operation of the system.

In general, and by way of example, embodiments of the present electrolysis systems and methods using crude methanol as the feedstock can operate under any of the various conditions set forth in Table 1 below.

TABLE 1

| | Methanol | Impurities* | | Flow | |
|---|---|---|---|---|---|
| Electricity | concentration | in feedstock | Current | rate of | |
| consumption | in the | (after | density | liquid | Cell |
| (kWh per kg | feedstock | dilution) | (mA per | feed | temper- |
| H₂) | (molar (M)) | (weight %) | cm²) | ml/min | ature |
| 5 | 2 | 0.01 | 10 | 0.5 | 30 |
| 10 | 3 | 0.1 | 50 | 0.5 | 32 |
| 15 | 4 | 1 | 100 | 1 | 34 |
| 20 | 5 | 5 | 150 | 1 | 36 |
| 25 | 6 | 6 | 200 | 1 | 38 |
| 30 | 7 | 7 | 250 | 1 | 40 |
| 35 | 8 | 8 | 300 | 2 | 42 |
| 40 | 9 | 9 | 350 | 2 | 44 |
| 45 | 10 | 10 | 400 | 2 | 46 |
| 50 | 11 | 11 | 450 | 2 | 48 |
| 55 | 12 | 12 | 500 | 3 | 50 |
| 60 | 15 | 15 | 600 | 3 | 55 |
| | 20 | 20 | 700 | 3 | 60 |
| | | | 1000 | 3 | 65 |
| 5-60 | 2-20 | 1-20 | 10-1000 | 0.5-4 | 30-60 |

The embodiments are not limited to a specific row in the table, conditions from one row can be used with conditions from a different row.
*The Impurities would include CO2, organics having a molecular weight greater than the molecular weight of the feedstock material, ethanol, sulfur, halides and any material that would poison the catalyst

Previous research on hydrogen gas generation by electrolyzing organic compounds have focused on the energy consumption by a single unit, particularly with the aim of maintaining low cell potential within the PEM electrolyzer during operation (for example, <0.7 V for methanol electro-oxidation). The present inventions have taken an entirely different approach from this prior work. Thus, in embodiments of the present systems the focus is on minimizing energy consumption in the integrated process of each conversion step: from production of the organic hydrogen carrier to hydrogen gas production at the point of use. Specifically, embodiments of the assemblies and methods set forth in this specification enable energy savings through bypassing distillation or similar upgrading process steps, by directly sourcing crude feedstock as the hydrogen carrier and overcoming the technical challenges introduced by the direct use of such feeds.

One particular challenge, which the present systems and methods overcome, in the direct use of crude methanol within electrolyzers is catalyst poisoning, which results from the presence of contaminants (e.g., larger organics, sulfur, halides, etc.), especially on the anode catalyst surfaces. For example, methanol synthesis from synthesis gas (“syngas”) feed, for example, sulfur-containing byproducts can be avoided by removing sulfur-containing feedstock impurities via upstream separation processes; however, longer chain oxygenates (those containing 2+ carbon atoms) are formed, in small concentrations, as byproducts of the methanol synthesis reaction. These oxygenates usually comprise 1-2 wt % (wet basis) of the crude methanol and can severely poison the anode catalysts upon their exposure to the catalyst layer in a downstream electrolyzer. These longer chain oxygenates, relative to methanol, oxidize at much lower rates and thus require higher potential (energy input) to undergo complete oxidization to form CO₂ and can instead accumulate on the catalysts, initiating polymerization reactions that ultimately block the catalytic sites active for methanol oxidation. These combined effects increase the energy consumption per unit of hydrogen gas produced over time and limit the maximum current density attainable for electrolyzer operation (i.e., rate of hydrogen gas production per area of catalyst). As shown in FIG. 3, the electricity required to produce 1 kg of hydrogen gas from crude methanol containing less than 3 wt % of organic impurities is 8-12 kWh greater than from grade methanol. The exposure of the catalyst to these organic contaminants further limits the current density practical for electrolyzer operation, as elevated cell potentials are apt to trigger the oxidation of PGM-based anode catalysts (e.g., FIG. 3, 301b). This can shorten the lifetime of anode catalysts leading to increased cost from more frequent catalyst replacement. From a broader economic standpoint, the present systems and methods overcome these compounding effects, which diminish the advantage of crude feedstock electrolysis relative to water electrolysis.

Preventing catalyst poisoning requires that contaminants avoid direct contact with the (anode) catalyst surface, which is achieved in embodiments of the present system by using a methanol-selective gas diffusion layer, which limits the transport of longer chain oxygenates. In a particular embodiment, the gas diffusion layer is thinner than 0.5 mm to facilitate good methanol and water mass transport.

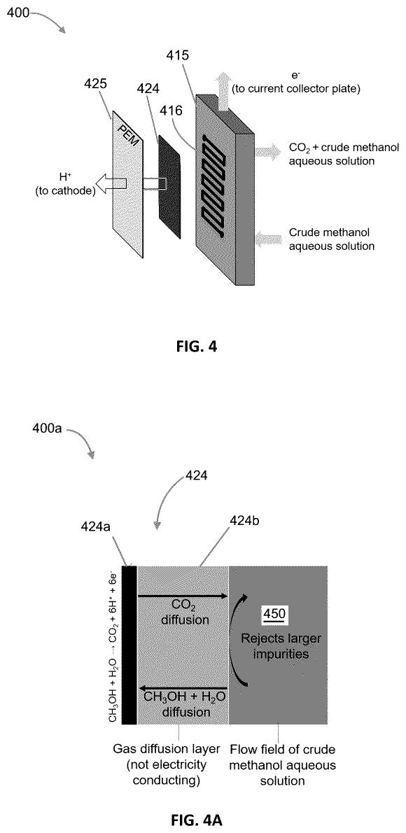

Turning to FIGS. 4 and 4A, there is shown an exploded perspective view of a gas diffusion electrode and PEM assembly 400, and an engaged cross sectional view 400a of the catalyst coated anode side gas diffusion membrane 424 of the assembly 400. The graphite plate 415 has flow channels 416 for the flow of the crude methanol solution. The flow channels 116 are in fluid contact with the catalyst coated anode side gas diffusion membrane 424 (e.g., the channels 116 permit the crude methanol solution to contact and flow by the membrane surface). The PEM 425 is also shown in the figure. FIG. 4A shows the cross section of the catalyst coated anode side gas diffusion membrane 424, which has a catalyst coating 424a on the side facing the PEM 424 and a gas diffusion layer 424b on the side facing the graphite plate 415. The flow of the crude methanol solution against the side of membrane 424b facing the graphite plate 415 is shown by area 450. The flow field is composed of a solution of the crude methanol feedstock (e.g., 2 M to 10 M methanol concentration) and is in direct contact with the gas diffusion layer 424b on the side without a catalyst coating 424a.

The following examples are provided to illustrate various embodiments of the present processes and systems. These examples are provided to illustrate various embodiments of the present electrolysis and electrochemical processes and systems. These examples are for illustrative purposes, may be prophetic, and should not be viewed as, and do not otherwise limit the scope of the present inventions.

### EXAMPLES

### Example 1

A selective gas diffusion layer protects the catalyst from being poisoned by the organic impurities in a crude liquid organic hydrogen carrier (LOHC) feedstocks, while allowing methanol or similarly small LOHC molecules to cross. This serves to reduce and preferably eliminate the need to and cost of distillation of crude feedstock, the need to and cost of frequent catalyst replacement and both.

The selective gas diffusion layer of the disclosure is a permeable material wherein the permeability allows for methanol and water to permeate through the layer while preventing impurities, including larger hydrocarbon materials, larger alcohols, olefins, and other impurities from permeating. Thus, preferably the selective gas diffusion layer is a membrane.

The selective gas diffusion layer may be an amorphous (e.g., polymeric) or crystalline material. In certain embodiments, the selective gas diffusion layer may be a nonwoven carbon fiber paper, a woven carbon cloth, a carbon foam, carbon nanotubes, graphene, a carbon nanotube felt, a polyolefin material, a polyethylene material, a polypropylene material, a polyester material, a polyphenylene sulfide material, or a zeolite or other naturally porous material for example. The selective GDL may also be a composite of two or more materials.

The pore size or permeability of the selective GDL material provides for selective permeation of reactive molecules in the feedstock while preventing impurities from passing through. In particular, the porous material is capable of selectively letting water and methanol permeate through while substantially forbidding the permeation of other impurities. In some example aspects: the selective GDL material has an average pore size of less than 0.5 μm; the porous material has an average pore size of less than 0.1 μm; or the porous material has an average pore size of less than 0.05 μm.

The selective GDL of the disclosure is capable of being compressed when used in an electrolyzer as described herein. In certain embodiments, the selective gas diffusion layer of the disclosure is capable of being compressed in the range of 1 to 25% of the uncompressed thickness. In particular embodiments, the selective gas diffusion layer of the disclosure is capable of being compressed in the range of 1 to 5% of the uncompressed thickness. This provides the advantage of having a thinner layer, e.g., membrane, for assembling into an electrolysis cell.

### Example 2

A catalyst is associated with the porous material. In particular embodiments, the catalyst is coated on the side of the porous material closest to the proton exchange membrane such that the catalyst is not exposed directly to the feedstock inlet flow. Preferably, the porous material is the selective gas diffusion layer, e.g., membrane.

In some embodiments, the catalyst is selected from the group comprising Pt, Au, Pd, Ru, Ir, Mn, Fe, Ni, Co, NiOx, Mn complexes, Fe complexes, MoSx, CdS, CdSe, and GaAs or combinations thereof. In particular embodiments, the catalyst is a Pt—Ru catalyst on the anode side and a Pt catalyst on the cathode side. In certain embodiments, the catalyst is coated on the side of the GDL that is not in contact with the crude feedstock.

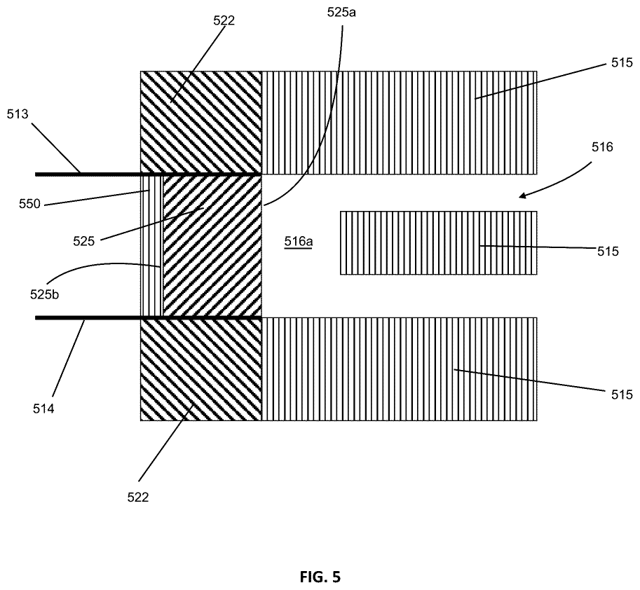

In another aspect, when the GDL material exhibits a high ohmic resistance, and thus acts as poor electric conductor, the GDL can be surrounded with a thin electric conducting layer (such as copper) to shuttle electrons from the graphite plate to the catalyst layer, as depicted in FIG. 5. Thus, FIG. 5 is a cross sectional schematic view of the assembly of a anode side of a cell and shows graphite plate 515, flow channel 116, that provides a flow field 516a for the crude methanol solution against the side 525a of the GDL 525, which can be a membrane. The catalyst 550, which can be a layer or coating, is positioned on Side 525b of GDL 525. A gasket 522 is used to seal the assembly. Electrical conductors 513 and 512 are also shown.

### Example 3

The GDL material can be reused to lower costs. The regenerating process requires calcining the crystalline GDL material in oxygen-containing environment to remove accumulated organic impurities that accumulate inside the pores.

### Example 4

A membrane electrode assembly, including, but not limited to, an electrolyzer, comprising: a cathode; an anode; at least one selective gas diffusion layer, and a catalyst. In particular embodiments, the electrolyzer includes two or more selective gas diffusion layers which sandwich a proton exchange membrane with catalysts layers on both sides. In such embodiments, the catalyst is coated on the side of the selective gas diffusion layers closest to the proton exchange membrane.

In embodiments, the proton exchange membrane can be a pure polymer membrane or a composite membrane. The proton exchange member can be a hydrocarbon polymer membrane, a fullerene based membrane, or a fluoropolymer membrane, including, but not limited to a perfluorosulfonic acid (PFSA) based polymer. As well as combinations of and variations of these.

### Example 5

An electrolyzer includes one or more current collector plates and one or more conductive plates, such as aluminum, titanium, gold, copper, graphene, or graphite plates that are engraved with flow fields (i.e., manifolds and channels of various patterns to achieve substantially uniform flow distribution) for liquid feedstock to flow through. In some embodiments the electrolyzer further includes separator plates between the current collector plates and the GDL. In general, planar plates will be utilized; however, the size, shape and geometry of the various plates can be adjusted based on the overall dimensions of the electrolyzer.

### Example 6

The electrolyzer includes one or more means of inlet flow through which crude feedstock can be passed through the electrolytic cell as a scrubbing or sweep flow to remove impurities accumulated on the feed side of the selective GDL. The electrolyzer can include one or more means of outlet through which hydrogen gas, carbon dioxide gas, and unreacted feedstock can be removed from the electrolyzer. In still other embodiments, the cell potential can be programed to perform cyclic voltammetry, pulse voltammetry, or other programmable potential changes, aside from normal working mode (constant cell potential or constant current densities) in order to clean and regenerate the contaminated electrode surface and extend the lifetime of electrodes.

### Example 7

The electrolyzer is operated at high current densities as such operation can reduce catalyst loading requirements and the associated costs of cell construction (i.e., lower capital cost). These conditions, however, require operating at higher cell potentials, at levels close to or above 1 V, wherein Pt-based catalysts may become oxidized and rendered inactive or less active for methanol oxidation. To avoid these catalyst oxidation phenomena, the methanol electrolyzer is preferably operated at 0.2-1 A cm⁻². However, the actual density depends on the level and type of impurities and cell temperature.

### Example 8

The electrolyzer is operated under standard temperature and pressure. In particular, the electrolyzer is generally operated at atmospheric pressure and at a temperature range of about 0 to 80° C.; more particularly, at a pressure of 1 atm and at a temperature range of about 0 to 65° C. For example, when gas phase water and gas phase methanol feedstocks are used, the cell temperature can go beyond 80° C.

### Example 9

Producing hydrogen gas from a crude methanol feedstock using the present systems and methods. The crude methanol feedstock contains an aqueous solution of methanol and water. The crude methanol feedstock contains up to 15% of impurities, up to 3% of impurities, 0.1-15% of impurities, 1-5% of impurities, 2-3% of impurity, by weight, with the impurities including materials such as longer chain alcohols, acids, such as formic acid, and ethers such as dimethyl ether

The crude feedstock is circulated past the anode of the electrolyzer resulting in the formation and separation of hydrogen gas and carbon dioxide. During operation, crude feedstock (methanol, impurities and water mixture) is circulated past the anode within the electrolyzer. In general, flow rates in the range of 1-500 milliliters/min/cm² of surface area are used. As the methanol and water mixture circulate through the anode, the following electrochemical reaction, for an exemplary methanol half-cell reaction occurs:

CH₃OH+H₂O→CO₂+6H⁺+6e⁻

The protons then travel through the PEM and get reduced at the cathode by the following half-cell reaction:

6H⁺+6e→3H₂

The hydrogen gas produced is removed from the electrolytic cell via one or more outlet ports positioned opposite the feedstock inlet, on the cathode side of the cell. Carbon dioxide produced by the above reaction is withdrawn along with unreacted feedstock through an outlet port on the anode side of the cell and separated from the solution in a gas-liquid separator. The unreacted feedstock (e.g., methanol-water, impurities solution) may then be re-circulated, partially or wholly, into the cell by a pump, if desired.

### Example 10

The energy penalty from direct use of crude methanol, which contains about 2 wt % of organic impurities (including alcohols, esters and ketones) or more, can be assessed with chronopotentiometry, performed across a range of current densities, which is proportional to the rate of hydrogen gas formation per area of electrode. Each methanol feedstock, crude or grade, is first diluted to 5 M (about 16 wt %) by deionized (DI) water. The electrolyzer comprises a perfluorosulfonic acid (PFSA) proton exchange membrane, PtRu as the anode catalyst, and Pt as the cathode catalyst. The catalysts were made into inks via sonication of solutions containing water, isopropanol and perfluorosulfonic acid. Then, the ink is sprayed using air brush onto carbon paper over a mask that has a square opening of 5 cm2. The loading of the catalyst was at 3 mg cm⁻² for both anode and cathode. The cell temperature was held at 50° C. and the flowrate of the dilute methanol solution was 1 mL/min. Commercial PtRu from Tanaka is used as anode catalyst, commercial Pt catalyst from the Fuel cell store is used as cathode catalyst. A 857 Redox Flow Cell Test System and a cell fixture from Scribner were used to perform the electrochemical tests. Production rate of hydrogen gas from the cathode and CO₂ from the anode were measured by water displacement and the gas purity was measured by SRI gas chromatography using He (for CO₂) and Ar (for hydrogen gas) as carrier gases.

An energy penalty is observed (FIG. 3) at current densities greater than 0.2 A cm⁻², which is defined as the excess of electricity required per kg H₂ of using crude methanol relative to grade methanol, at a given current density. The penalty measured on this specific crude sample was about 8-12 kWh/kg H₂. The selective GDL will allow this penalty to be minimized or avoided.

Comparisons with energy requirements involved in water electrolysis can be performed with the same apparatus, replacing the anode catalyst with the state-of-the-art water electrolysis catalyst, IrO₂, and supplying DI water as the feed source instead of methanol. FIG. 3 shows that despite the energy penalties imparted by the presence of organic impurities, crude methanol electrolysis requires about 20 kWh/kg H₂ lower energy consumption relative to water electrolysis in order to generate hydrogen gas at similar rates (e.g., at 0.5 A cm⁻² operation).

### Example 11

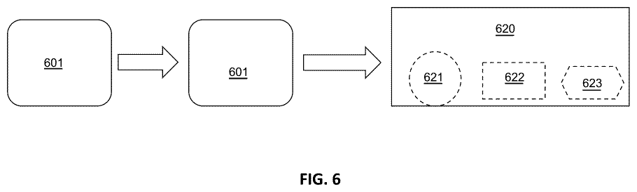

Turning to FIG. 6 there is shown a schematic of a crude methanol fuel source method and uses. The crude methanol is made 601, for example from flare gas, at a flare gas location. The crude methanol can be collected at a location 601, which can be a distribution location as well. A mode of transportation 620, which can be a vehicle, a boat, a car, a truck, heavy equipment, a bus, etc. has a fuel tank 621 for holding the crude methanol. The mode of transportation 620 has an embodiment of an electrolysis system 622 as taught and described in this specification. The electrolysis system 622 converts the crude methanol into Hydrogen, which is then used by a power module 623. The power module 623 can be a fuel cell, an internal combustion engine, a hybrid system and combinations and variations of these.

It is noted that there is no requirement to provide or address the theory underlying the novel and groundbreaking advantages, performance or other beneficial features and properties that are the subject of, or associated with, embodiments of the present inventions. Nevertheless, various theories are provided in this specification to further advance the art in this important area, and in particular in the important area of hydrocarbon exploration, production and downstream conversion. These theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the conductivities, fractures, drainages, resource production, chemistries, and function-features of embodiments of the methods, articles, materials, devices and system of the present inventions; and such later developed theories shall not limit the scope of protection afforded the present inventions.

The various embodiments of devices, systems, activities, methods and operations set forth in this specification may be used with, in or by, various processes, industries and operations, in addition to those embodiments of the Figures and disclosed in this specification. The various embodiments of devices, systems, methods, activities, and operations set forth in this specification may be used with: other processes industries and operations that may be developed in the future: with existing processes industries and operations, which may be modified, in-part, based on the teachings of this specification; and with other types of gas recovery and valorization systems and methods. Further, the various embodiments of devices, systems, activities, methods and operations set forth in this specification may be used with each other in different and various combinations. Thus, for example, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this specification. Thus, the scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

1. An assembly for use in a system to conduct an electrochemical reaction, the assembly comprising:
a. a first member, having flow channels therein;
b. a current collector, in electrical contact with the first member;
c. a screening gas diffusion material, in fluid contact with the flow channels, whereby a crude feedstock in the flow channels would be in fluid communication with a first side of the screening gas diffusion material;
d. a catalyst adjacent a second side of the screening gas diffusion material; and,
e. wherein the assembly is configured for placement in the system so that the catalysis is positioned facing an exchange membrane and away from the crude feedstock in the flow channels.

2. The assembly of claim 1, wherein:
a. the first member comprises graphite;
b. the screening gas diffusion material has a porosity defined by a pore size of less than about 0.5 μm;
c. the catalyst comprises at least one of Ni, Co, NiOx, Mn complexes, Fe complexes, MoSx, CdS, CdSe, and GaAs.

3. The assembly of claim 1, wherein:
a. the first member comprises aluminum;
b. the screening gas diffusion material defines a layer having a porosity defined by a pore size of less than about 0.5 μm;
c. the catalyst comprises at least one of Pt, Au, Pd, Ru, Ir, Mn and Fe.

4. The assembly of claim 1, wherein: the screening gas diffusion material comprises at least one of a nonwoven carbon fiber paper, a woven carbon cloth, a carbon foam, a carbon nanotube, graphene, a carbon nanotube felt, a polyolefin, a polyethylene, a polypropylene, a polyester, a polyphenylene sulfide and a zeolite.

5. The assembly of claim 2, wherein: the screening gas diffusion material comprises at least one of a nonwoven carbon fiber paper, a woven carbon cloth, a carbon foam, a carbon nanotube, and graphene.

6. The assembly of claim 3, wherein: the screening gas diffusion material comprises at least one of a carbon nanotube felt, a polyolefin, a polyethylene, a polypropylene, a polyester, a polyphenylene sulfide and a zeolite.

7. The assembly of claim 1, wherein the screening gas diffusion material is a layer.

8. The assembly of claim 1, wherein the screening gas diffusion material is a membrane.

9. The assembly of any of claim 2, wherein the pore size is less than 0.1 μm.

10. The assembly of any of claim 1, wherein the catalyst consists essentially of a PtRu based catalyst.

11. The assembly of any of claim 1, wherein:
a. the assembly is configured to operate as an anode in the system; and wherein the assembly is configured to process a crude methanol feedstock in the flow channels; and,
b. wherein the crude methanol feedstock has 2% or more impurities, and the impurities comprise organic molecules having a molecular weight greater than that of methanol.

12. The assembly of claim 1, wherein the system is a fuel cell.

13. The assembly of claim 1, wherein the system is an electrolyzer.

14. A system for performing electrolysis of a crude feedstock, wherein the crude feedstock comprises a primary component, the system comprising:
a. a first end having an inlet port and a return port;
b. a second end having an outlet port;
c. a first flow field component, having a first flow channel in fluid communication with the inlet port and the return port of the first end;
d. a second flow field component, having a second flow channel in fluid communication with the outlet port of the second end;
e. a first electrical connector affixed to the first flow field component;
f. a second electrical connector affixed to the second flow field component; and,
g. a screening gas diffusion assembly between the first and second flow field components, whereby a first side of the screening gas diffusion assembly is in fluid communication with the flow channel of the first flow field component; and whereby a second side of the screening gas diffusion assembly is in fluid communication the flow channel of the second flow field component.

15. The system of claim 14, wherein the screening gas diffusion assembly comprises:
a. a first gas diffusion material;
b. an exchange membrane;
c. a first catalyst;
d. wherein the first gas diffusion material is in fluid communication with the inlet and return port of the first end component;
e. wherein the first gas diffusion material is in fluid communication with the exchange membrane;
f. wherein the gas diffusion material is configured and positioned to screen an impurity in the crude feedstock from the catalysis.

16. The system of claim 15, whereby the gas diffusion material is configured to protect the catalyst from poising by the impurity.

17. The system of claim 15, whereby the gas diffusion material is configured to reduce an energy penalty caused by the impurities in the feedstock.

18. The system of claim 16, whereby the gas diffusion material is configured to reduce an energy penalty caused by the impurities in the feedstock.

19. The system of claim 17, whereby the reduction in the energy penalty is about 5 by kWh/kg H₂ or more, for a current density of at least about 0.2 A cm⁻².

20. The system of claim 18, whereby the reduction in the energy penalty is about 5 by kWh/kg H₂ or more, for a current density of at least about 0.2 A cm⁻².

21. The system of claim 15, wherein the gas diffusion material is a layer.

22. The system of claim 15, wherein the gas diffusion material is a membrane.

23. The system of claim 14, wherein the screening gas diffusion assembly comprises:
a. a second gas diffusion material;
b. a second catalyst;
c. wherein the second gas diffusion material is in fluid communication with the outlet port of the second end; and,
d. wherein the second gas diffusion material is in fluid communication with the exchange membrane.

24. The system of claim 23, wherein, the first and second catalyst are different.

25. The system of claim 23, wherein the second gas diffusion material is a layer.

26. The system of claim 23, wherein the second gas diffusion material is a membrane.

27. The system of claim 23, wherein:
a. the first, the second or both gas diffusion materials has a porosity defined by a pore size of less than about 0.5 μm; and,
b. the first catalyst comprises at least one of Ni, Co, NiOx, Mn complexes, Fe complexes, MoSx, CdS, CdSe, and GaAs.

28. The system of claim 23, wherein:
a. the first, the second or both gas diffusion materials has a porosity defined by a pore size of less than about 0.5 μm; and
b. the first catalysts comprises at least one at least one of Pt, Au, Pd, Ru, Ir, Mn and Fe.

29. The system of claim 23, wherein the first, the second or both gas diffusion materials comprise at least one of a nonwoven carbon fiber paper, a woven carbon cloth, a carbon foam, a carbon nanotube, graphene, a carbon nanotube felt, a polyolefin, a polyethylene, a polypropylene, a polyester, a polyphenylene sulfide and a zeolite.

30. The system of claim 23, wherein the first, the second or both gas diffusion materials comprise at least one of a nonwoven carbon fiber paper, a woven carbon cloth, a carbon foam, a carbon nanotube, and graphene.

31. The system of claim 23, wherein the first, the second or both gas diffusion materials comprise at least one of a carbon nanotube felt, a polyolefin, a polyethylene, a polypropylene, a polyester, a polyphenylene sulfide and a zeolite.

32. The system of claim 15, wherein the first, the second or both gas diffusion materials has a pore size of about 0.5 μm to 0.05 μm.

33. The system of claim 15, wherein the first catalyst consists essentially of a PtRu based catalyst.

34. The system of claim 15, wherein the first, the second or both flow field components are plates comprising graphite.

35. The system of claim 15, wherein the first, the second or both flow field components are plates comprising aluminum.

36. The system of claim 1, wherein the exchange membrane is a proton exchange membrane.

37. A method of operating the system of claim 14, wherein the crude feedstock primary component is methanol.

38. The method of operating the system of claim 14, wherein the crude feedstock primary comment consists of methanol.

39. (canceled)

40. (canceled)

41. (canceled)

42. (canceled)

43. (canceled)

44. A method of producing hydrogen gas from a crude methanol feedstock in an electrolysis assembly, the method comprising:
a. flowing the crude methanol feedstock into an inlet of an electrolysis assembly;
b. in the electrolysis assembly, placing the crude methanol feedstock in contact with a screening gas diffusion assembly;
c. the screening gas diffusion assembly screening an impurity in the crude feedstock from a catalyst;
d. apply electricity to the electrolysis assembly to generate hydrogen from the crude methanol feedstock; and,
e. wherein, an energy penalty is reduced.

45. The method of claim 44, wherein the energy penalty is reduced by about 5 kWh/kg H₂ or more, for a current density of at least about 0.2 A cm⁻².

46. The method of claim 44, wherein the energy penalty is reduced by about 2 to 15 kWh/kg H₂, for a current density of about 0.2 A cm⁻² to 0.7 A cm⁻².

47. The method of claim 44, wherein the electrolysis assembly comprises a screening gas diffusion assembly comprises a material having an average pore size of less than about 0.5 μm.

48. The method of claim 44, wherein the electrolysis assembly comprises the screening gas diffusion assembly comprises a material having an average pore size of less than about 0.1 μm.

49. The method of claim 44, wherein the electrolysis assembly comprises the screening gas diffusion assembly comprises a material having an average pore size of less than about 0.05 μm.

50. The method of claim 44, wherein the electrolysis assembly comprises the screening gas diffusion assembly comprises a material having an average pore size of 0.5 μm to about 0.05 μm.

51. A transportation device comprising: a fuel tank, the fuel tank comprising a crude methanol; the system of claim 14, and a power module.

52. The transportation device of claim 51, wherein the device is selected from the group consisting of a car, a truck, a buss, a ship, and a train locomotive.
